(19) United States
(12) Patent Application Publication
(10) Pub. No.: US 2018/0361652 A1
(43) Pub. Date: Dec. 20, 2018

(54) TECHNIQUES FOR FLUID CONTROL IN ADDITIVE FABRICATION AND RELATED SYSTEMS AND METHODS

(71) Applicant: Massachusetts Institute of Technology, Cambridge, MA (US)

(72) Inventors: Wojciech Matusik, Lexington, MA (US); Subramanian Sundaram, Somerville, MA (US)

(73) Assignee: Massachusetts Institute of Technology, Cambridge, MA (US)

(21) Appl. No.: 15/405,128

(22) Filed: Jan. 12, 2017

Related U.S. Application Data
(60) Provisional application No. 62/277,764, filed on Jan. 12, 2016.

(51) Int. Cl. B29C 64/112; B29C 64/124; B29C 64/336

(52) U.S. Cl. CPC B29C 64/112; B33Y 10/00; B29C 64/336; B29C 64/124

(57) ABSTRACT

According to some aspects, a method is provided of forming an object via additive fabrication, the method comprising forming a first layer of the object by depositing a plurality of droplets of a first liquid and curing the first liquid to form solid material, the first layer including a region of a first solid material, and a region of a second solid material in contact with the region of the first solid material, and depositing a second liquid onto the region of the first solid material and at least part of the region of the second solid material, wherein the second liquid, once deposited, uniformly spreads over the region of the first solid material whilst exhibiting partial wetting over the at least part of the region of the second solid material.

### CROSS-REFERENCE TO RELATED APPLICATIONS

The present application claims the benefit under 35 U.S.C. § 119(e) of U.S. Provisional Patent Application No. 62/277,764, filed Jan. 12, 2016, titled “Method to Control and Create Multi-Domain Function and Intelligence in 3D,” which is hereby incorporated by reference in its entirety.

### STATEMENT REGARDING FEDERALLY-SPONSORED RESEARCH AND DEVELOPMENT

This invention was made with Government support under Contract No. N66001-15-C-4030 awarded by the Space and Naval Warfare Systems Center and under Grant No. U.S. Pat. No. 1,409,310 awarded by the National Science Foundation. The Government has certain rights in the invention.

### BACKGROUND

Additive fabrication, e.g., 3-dimensional (3D) printing, provides techniques for fabricating objects, typically by causing portions of a building material to solidify and/or combine at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering, inkjet, polyjet, or combinations thereof. Many additive fabrication techniques build parts by forming successive layers, which are usually cross-sections of the desired object. Typically each layer is formed such that it adheres to either a previously formed layer or a substrate upon which the object is built.

### SUMMARY

According to some aspects, a method is provided of forming an object via additive fabrication, the method comprising forming a first layer of the object by depositing a plurality of droplets of a first liquid and curing the first liquid to form solid material, the first layer including a region of a first solid material, and a region of a second solid material in contact with the region of the first solid material, and depositing a second liquid onto the region of the first solid material and at least part of the region of the second solid material, wherein the second liquid, once deposited, uniformly spreads over the region of the first solid material whilst exhibiting partial wetting over the at least part of the region of the second solid material.

According to some embodiments, the first liquid is a photopolymer and curing the first liquid comprises directing actinic radiation onto the photopolymer.

According to some embodiments, curing the first liquid comprises chemically reacting the first liquid with one or more other substances to form the solid material.

According to some embodiments, the second solid material has a lower surface energy than the first solid material.

According to some embodiments, the first solid material is a rigid material and the second solid material is an elastic material.

According to some embodiments, the method further comprises directing heat onto the second liquid that causes evaporation of a solvent component of the second liquid.

According to some embodiments, the second liquid comprises an electrically conductive material and/or a semiconductive material.

According to some embodiments, the second liquid comprises a dielectric material.

According to some embodiments, the electrically conductive material is poly(3,4-ethylenedioxythiophene) doped with polystyrene sulphonate (PEDOTPSS).

According to some embodiments, the electrically conductive material is silver.

According to some embodiments, the second liquid comprises an organic solvent.

According to some embodiments, the method further comprises forming additional solid material onto the second liquid, then subsequently removing the second liquid whilst in a liquid form.

According to some aspects, an additive fabrication device is provided for forming an object from a plurality of layers of solid material, the additive fabrication device comprising a build platform, one or more nozzles configured to deposit liquid droplets onto the build platform or onto previously formed solid material, the one or more nozzles including a first nozzle configured to deposit droplets of a first liquid, and a second nozzle configured to deposit droplets of a second liquid, a reactive element configured to cure the droplets of the first liquid to form a first solid material and to cure the droplets of the second liquid to form a second solid material, the second solid material having a lower surface energy than the first solid material, and at least one printhead configured to deposit a third liquid onto previously formed first and second solid material.

According to some embodiments, the reactive element is a source of actinic radiation and the first and second liquids are liquid photopolymers.

According to some embodiments, the source of actinic radiation comprises a plurality of ultraviolet LEDs.

According to some embodiments, the first and second liquids are epoxies and the reactive element is configured to chemically react with the epoxies to form solid material.

According to some embodiments, the one or more nozzles are thermally coupled to a heater.

According to some embodiments, the additive fabrication device further comprises a convection heater configured to direct heat onto the third liquid to cause evaporation of a solvent component of the third liquid.

According to some embodiments, the first solid material is a rigid material and the second solid material is an elastic material.

According to some embodiments, the first nozzle is configured to deposit the first liquid according to a first voltage waveform that controls droplet production of the first liquid, and the second nozzle is configured to deposit the second liquid according to a second voltage waveform that controls droplet production of the second liquid, different from the first voltage waveform.

According to some embodiments, the third liquid comprises an electrically conductive material and/or a semiconductive material.

According to some embodiments, the electrically conductive material is silver.

According to some embodiments, the third liquid comprises an organic solvent.

According to some embodiments, the third liquid comprises an inorganic solvent.

According to some aspects, a method is provided of forming a first layer of the object by depositing a plurality of droplets of a first liquid and curing the first liquid to form solid material, the first layer including at least a first concave region, and depositing a second liquid onto the solid material, wherein at least some of the second liquid, once deposited into the first concave region, flows under gravity toward a lowest point of the first concave region.

According to some embodiments, the first liquid is a photopolymer and curing the first liquid comprises directing actinic radiation onto the photopolymer.

According to some embodiments, curing the first liquid comprises chemically reacting the first liquid with one or more other substances to form the solid material.

According to some embodiments, the method further comprises directing heat onto the second liquid that causes evaporation of a solvent component of the second liquid.

According to some embodiments, the second liquid comprises an electrically conductive material and/or a semiconductive material.

According to some embodiments, the second liquid comprises a dielectric material.

According to some embodiments, the second liquid comprises an organic solvent.

According to some aspects, a method is provided of forming an object via additive fabrication, the method comprising forming a first layer of the object by depositing a plurality of droplets of a first liquid and curing the first liquid to form solid material, the first layer including a region of a first solid material, depositing a second liquid onto the region of the first solid material, wherein the second liquid, once deposited, exhibits partial wetting, and forming additional solid material over the second liquid and in contact with the second liquid, thereby encapsulating the second liquid at least in part by the first layer and the additional solid material.

According to some embodiments, the second liquid is a functional liquid.

According to some embodiments, the second liquid is an electrolyte solution.

According to some embodiments, the encapsulation encapsulates a first volume, and the first volume is substantially filled by the second liquid.

According to some embodiments, the method further comprises forming solid walls around the second liquid.

According to some aspects, a method is provided of forming an object via additive fabrication, the method comprising forming a first layer of the object by depositing a plurality of droplets of a first liquid and curing the first liquid to form solid material, the first layer including a region of a first solid material, forming a well structure on the first layer, depositing a second liquid inside the well structure and onto the region of the first solid material, and forming additional solid material over the second liquid and in contact with the second liquid, thereby encapsulating the second liquid at least in part by the first layer, the well structure, and the additional solid material.

According to some embodiments, the second liquid is a functional liquid.

According to some embodiments, the second liquid is an electrolyte solution.

According to some embodiments, the encapsulation encapsulates a first volume, and the first volume is substantially filled by the second liquid.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIGS. 1A-1B depict the wettability of two different solid materials produced via additive fabrication, according to some embodiments;

FIG. 2 is a cross-sectional schematic depicting fluid control using different additively fabricated material surfaces having different surface energies, according to some embodiments;

FIGS. 3A-3B are cross-sectional schematics depicting evaporation of solvent from a liquid solution deposited during additive fabrication, according to some embodiments;

FIG. 4A-4C are cross-sectional schematics depicting encapsulation of a liquid during additive fabrication upon a low surface energy material, according to some embodiments;

FIG. 5A-5C are cross-sectional schematics depicting encapsulation of a liquid during additive fabrication upon a high surface energy material, according to some embodiments;

FIG. 6 illustrates an additive fabrication device suitable for practicing some aspects of the present disclosure, according to some embodiments;

FIG. 7A is a photograph of a sensory composite device produced via additive fabrication, according to some embodiments;

FIG. 7B is an exploded view of the sensory composite device shown in FIG. 7A, according to some embodiments;

FIG. 7C is an equivalent circuit diagram of the strain sensor ladder, the common source amplifier and electrochromic pixel of the device of FIG. 7A, according to some embodiments;

FIG. 7D is a cross-sectional schematic of an additively fabricated electric contact structure, according to some embodiments;

FIG. 7E is a cross-sectional schematic of an additively fabricated transistor structure, according to some embodiments; and

FIG. 8 illustrates an example of a computing system environment on which aspects of the invention may be implemented.

### DETAILED DESCRIPTION

While additive fabrication techniques are developing rapidly, such techniques are still limited by the types of materials that can be used in fabrication. For instance, many additive fabrication technologies are limited to use various types of plastics to form objects. Some additive fabrication devices have been developed that form conductive materials, but these devices rely on materials that solidify rapidly when exposed to air. Consequently, the shape of the deposited conductive materials depend greatly upon the deposition mechanism, and in general, such devices lack sufficient control to produce uniformly thin layers of material.

The inventors have recognized and appreciated that producing complex devices via additive fabrication may involve the fabrication of functional materials, such as dielectrics, piezoelectrics, ferroelectrics, liquid crystals, semiconductors and conductors. In many cases, it may be desirable that the functional materials be formed in substantially uniformly thin layers (e.g., as a thin film). If functional materials could be produced through additive fabrication, this may allow the production of functional devices and/or composites, such as sensors, transistors or amplifiers through additive fabrication, thereby greatly expanding the types of devices that can be formed through additive fabrication.

The inventors have further recognized and appreciated that production of functional materials at low temperatures (e.g., <500° C.) may be achieved by depositing liquids as part of the additive fabrication process. Such liquids may include solvent-based liquids that can be heated to produce thin films and/or may include liquids that remain in a fluid state (e.g., a liquid electrolyte or other functional liquid). In either case, however, deposited liquids may have a natural tendency to flow across a surface on which they are deposited, making accurate small-scale fabrication difficult or impossible without means to control the liquid flow.

To address these challenges, the inventors have developed techniques for fluid control that comprise controlling the surface energy of materials upon which a liquid is deposited. In addition, the surface texture and/or surface geometry of the materials can be selected to further control the flow of fluid. These techniques allow for, amongst other things, the confining of liquids on solid material layers with high fidelity. Moreover, these techniques also allow for the production of defect-free, uniform, thin materials that may be used to produce functional devices and/or composites.

According to some embodiments, an additive fabrication device may include one or more printheads that, together, are configured to form objects from at least two different solid materials. The solid materials may be selected to have different surface energies so that liquids deposited on each solid material flow differently. For instance, a particular liquid may exhibit complete wetting when deposited on a first solid material, yet may exhibit only partial wetting when deposited on a second solid material that has a lower surface energy than the first solid material. Furthermore, since different liquids may respond differently to the same solid material, the solid materials may be selected based on the types of liquids to be used in the additive fabrication process to ensure that each of the liquids can be controlled as desired. Accordingly, by selecting surface energies of the solid materials deposited, and by selecting those surface energies based on the response of liquids to be deposited upon those solid materials, the flow of those liquids over the solid materials may be controlled during additive fabrication.

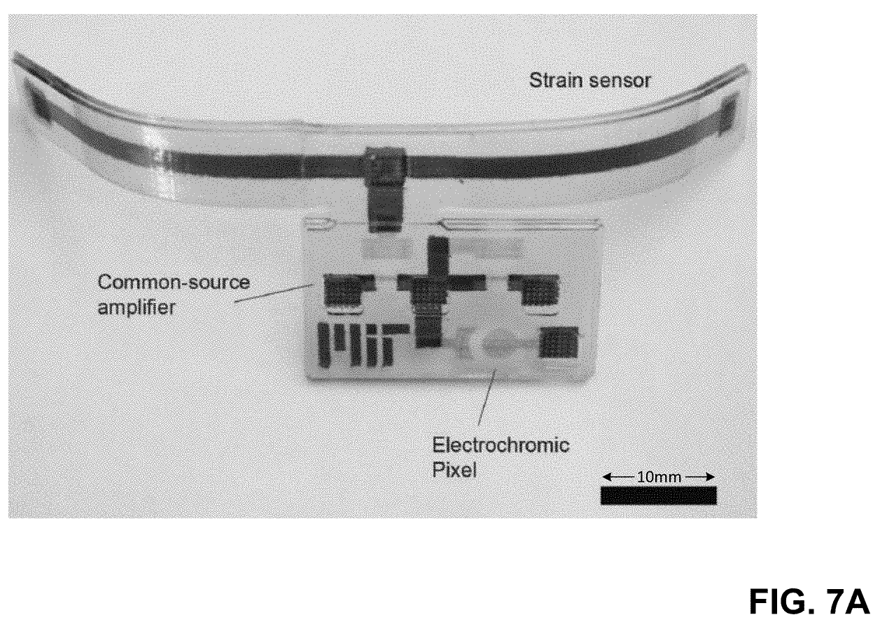

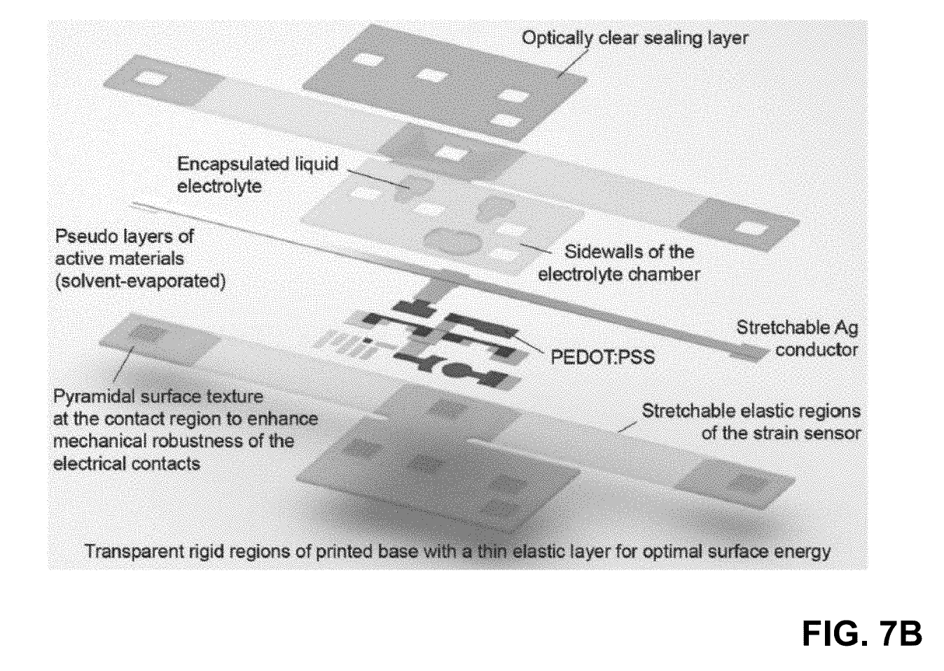

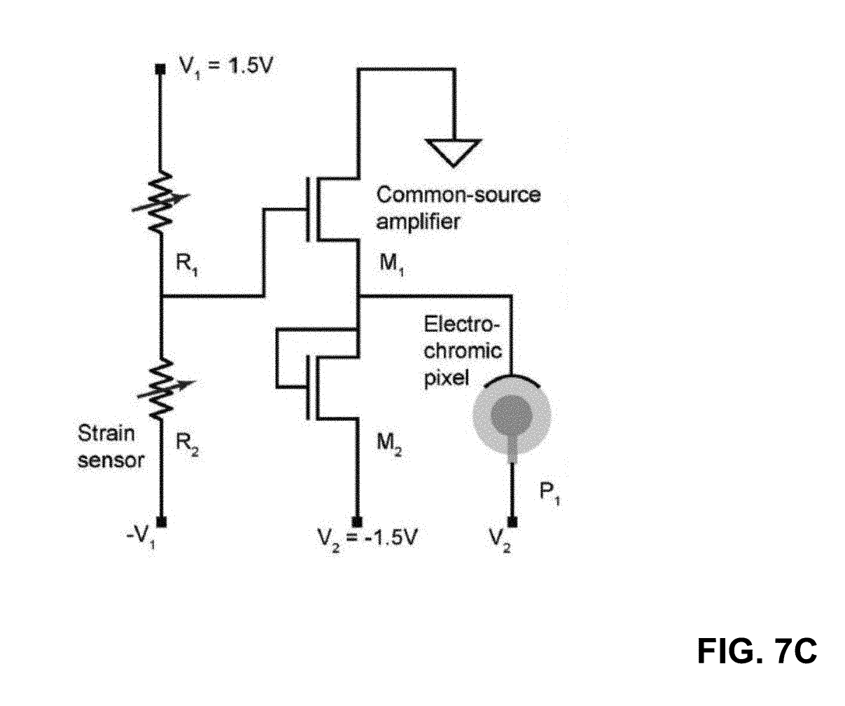

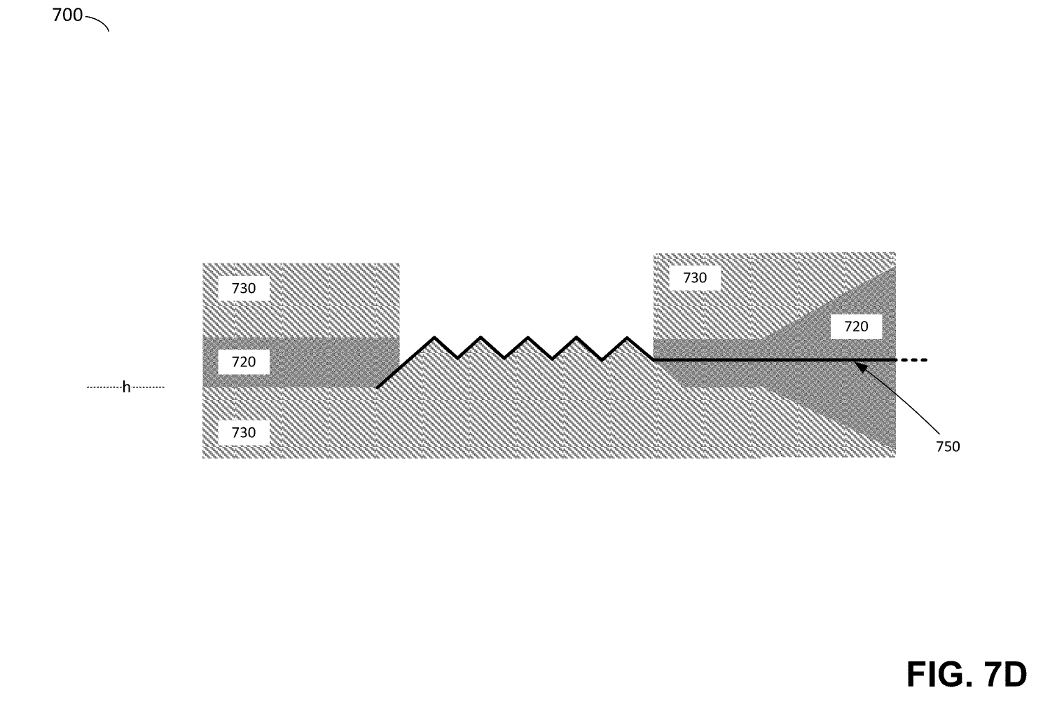

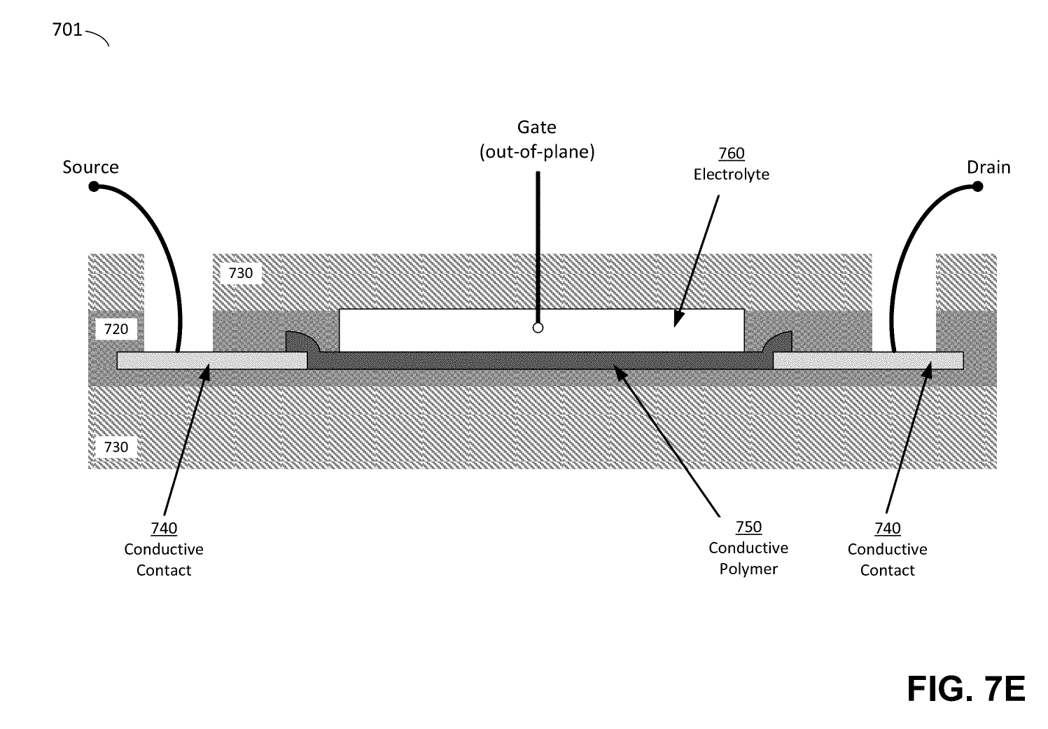

According to some embodiments, an additive fabrication device may be configured to form surfaces that are not flat in a direction in which layers are formed. In particular, the surfaces may be formed to have recessed portions and non-recessed portions that may be used to control the flow of fluid that is deposited onto the surface. For instance, a surface with solid convex features will also feature concave voids in the surface (an example of this is discussed in relation to FIG. 7D below). Liquid deposited onto such a surface that exhibits wetting behavior on the surface will more favorably flow over the surface and into the concave regions due to gravity. Thus, the shape of the surface may be selected to control the flow of fluid over the surface.

According to some embodiments, an additive fabrication device may be configured to deposit liquids and encapsulate the liquid within one or more deposited solid materials. In some cases, flow of the liquid over a solid material surface may be controlled so that the encapsulation structure (e.g., sidewalls and a ceiling) may be built around the deposited liquid. In other cases, a well or other containing structure may be fabricated from solid material(s) and a liquid deposited into the containing structure. The liquid may then be encapsulated by fabricating additional material over the top of the containing structure. In some embodiments, liquid may be encapsulated such that little or no air (or other gases) are enclosed within the encapsulated volume with the liquid.

In some embodiments, deposited liquid may be used as a support material. Support material is often used in additive fabrication when solid material to be formed would overhang by an amount that might cause structural instability of the overhanging material. Typically, additional solid material acting as a support may be formed so that the overhanging regions can be formed on the support. After fabrication, the support material may be removed. However, this removal process is generally imperfect and can often leave residual solid material on the object, negatively affecting the desired object. Using the techniques described herein, liquid may be deposited and controlled in such a way to be used as a support material. Solid material may be formed onto the liquid when it is acting as a support, and then subsequently the liquid can be removed. In this approach, since no solid material needs to be used as a support structure, no residual solid material is left as a result of the process and consequently the fabricated object can be shaped as intended.

According to some embodiments, an additive fabrication device may be configured to control production of liquid droplets according to waveforms optimized for each liquid. A liquid dispenser may include an actuator (e.g., a piezoelectric actuator) configured to be controlled by the additive fabrication device to produce a droplet of the liquid that falls onto a surface of the object being fabricated. Different liquids may, however, produce various droplet sizes and/or may produce satellite drops (undesired secondary droplets) if the actuator is not optimized for each liquid. As such, actuation parameters, such as a voltage waveform, may be determined for each liquid to produce uniformly-sized single droplets of each liquid from a printhead of the additive fabrication device. These waveforms may be stored in a suitable computer readable storage medium and accessed by the additive fabrication device to produce liquid in a controlled manner.

According to some embodiments, an additive fabrication device may be equipped with a heater to cure solvent-based liquid(s) produced by the device. As discussed above, it may be advantageous to produce uniform thin films in an object being additively fabricated. This may be achieved by controlling the flow of a solvent-based liquid upon a surface and then applying heat to evaporate the solvent, leaving a thin film. The heat may be applied after depositing each layer of the object being fabricated, or may be applied after the deposition of several layers. The heater may be directional in nature, such as a nozzle that produces hot air, which may be targeted at desired regions of an object being fabricated. The temperature of the heater may be selected to be sufficient to cure the desired solvent-based liquid(s) whilst not causing damage (e.g., deformation) to solid materials of the object being fabricated.

According to some embodiments, an additive fabrication device may be configured to form one or more solid materials by depositing droplets of a photopolymer and by curing the photopolymer into solid material using a source of actinic radiation.

According to some embodiments, an additive fabrication device may be configured to form one or more solid materials by chemically reacting a deposited liquid with one or more other substances to form a solid material. For instance, the deposited liquid may be reacted to form a material such as polyurethane or to form an epoxy. In some cases, the deposited liquid may be cured by chemically reacting it with another deposited liquid (e.g., by depositing one liquid onto the other liquid or by other depositing the liquids in contact with one another). In some cases, a deposited liquid may be cured by reacting it with one or more of: heat, water (e.g., moisture in the air or otherwise) and/or a hardener.

According to some embodiments, an additive fabrication device may be configured to form solid materials that include at least one rigid material and at least one elastic material. By varying the amounts and locations of these two types of materials, a wide variety of mechanical matrixes may be produced to support components of functional devices and/or composites. In some embodiments, an additive fabrication device may be configured to form solid materials from materials having various optical properties (e.g., opaque material, transparent materials, etc.) and/or that are different colors.

Following below are more detailed descriptions of various concepts related to, and embodiments of, techniques for fluid control in additive fabrication. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

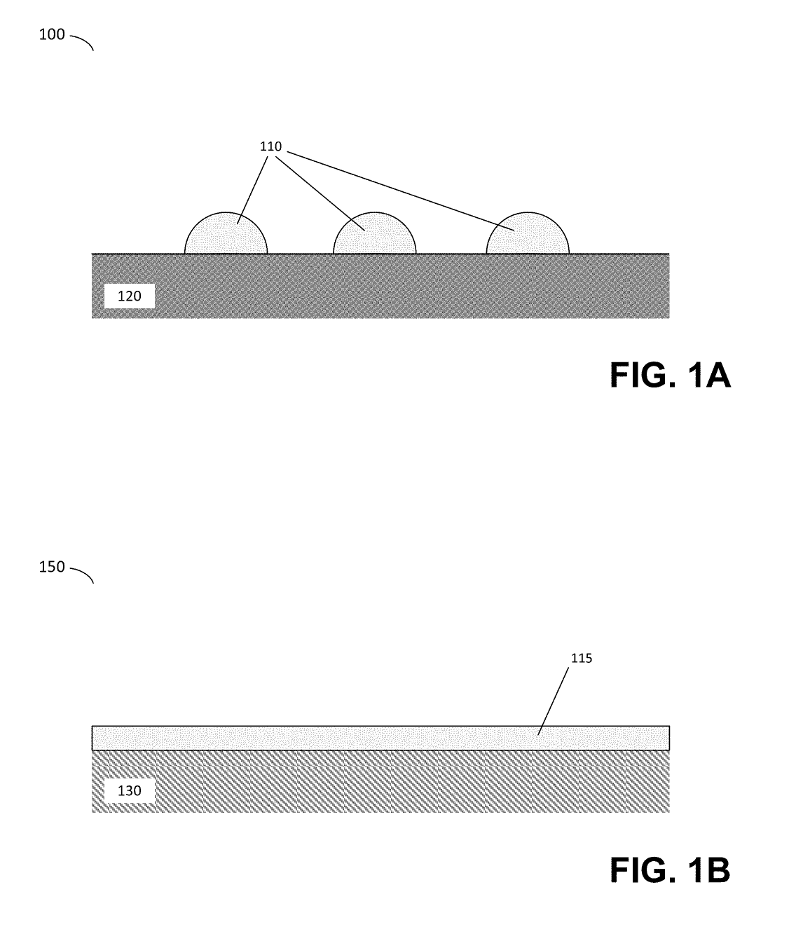

FIGS. 1A-1B depict the wettability of two different solid materials produced via additive fabrication, according to some embodiments. As discussed above, techniques described herein control fluid flow by controlling the surface energy of solid material upon which the liquids are deposited.

FIG. 1A illustrates a solid material 120, formed by an additive fabrication device, upon which a liquid 110 has been deposited by the device. As shown in the example of FIG. 1A, the liquid 110 exhibits partial wetting as the surface energy of the solid material 120 is sufficiently low to inhibit flow of the liquid over the surface of the solid material. In comparison, FIG. 1B illustrates a solid material 130, formed by an additive fabrication device, upon which the same liquid 110 has been deposited by the device. As shown in the example of FIG. 1B, in this case the liquid 110 covers the solid surface (i.e., exhibits full wetting).

As defined by Young's equation, when a liquid comes in contact with a solid in a gaseous environment (e.g., air), there is a mechanical relationship between the contact angle that the liquid makes with the solid, the surface tension of the liquid, the interfacial tension between the liquid and the solid, and the surface (free) energy of the solid. The balance of these factors determine whether the wetting state of the liquid will be full, partial, or non-wetting. As such, the wetting state depends upon the properties of the liquid as well as the surface energy of the solid material. Accordingly, it may be possible that a liquid different from liquid 110 in the example of FIGS. 1A-1B would exhibit different wetting states than those shown in FIGS. 1A-1B when deposited onto the same solid materials 120 and 130. For instance, a different liquid may exhibit full wetting on both solid materials 120 and 130 (in contrast to liquid 110, which exhibits only partial wetting on solid material 120).

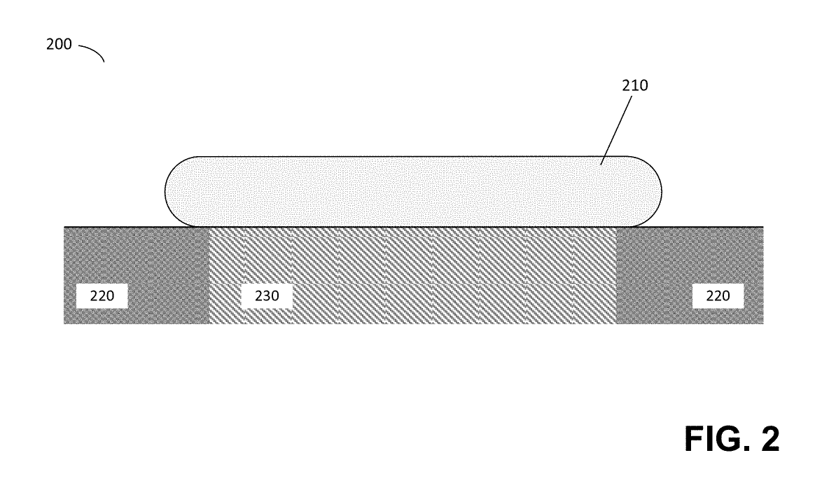

As discussed above, the inventors have recognized and appreciated that by controlling the surface energy of solid materials upon which a liquid is deposited, the liquid may be confined with high fidelity. As shown in FIG. 2, this may be achieved by combining the types of liquid behaviors exhibited in FIGS. 1A and 1B.

FIG. 2 is a cross-sectional schematic depicting fluid control using different additively fabricated material surfaces having different surface energies, according to some embodiments. In the example of FIG. 2, solid materials 220 and 230 have been formed by an additive fabrication device in adjacent regions of an object being fabricated, and a liquid 210 has been deposited onto the solid material 230 and onto part of the solid material 220. The surface energy of solid material 230 is such that the liquid 210 covers the surface of solid material 230, yet the surface energy of solid material 230 is such that the liquid 210 exhibits only partial wetting on the surface of the solid material 220.

The combined effect, in the example of FIG. 2, is a uniformly thick layer of liquid that is controlled to largely cover only the solid material 230, whilst making only a small contact area with the solid material 220 at the edges. Thus, by fabricating solid materials with different surface energies in a selected pattern, a uniform, thin layer of liquid may be controlled and confined to a region of comparatively high surface energy with high fidelity.

In practice, the structure of FIG. 2 may be fabricated by initially forming one or more layers in which a region of solid material 220 is adjacent and in contact with solid material 230. Subsequently, the liquid 210 is deposited onto at least part of the solid material 230. In some cases, the liquid may flow across the surface of solid material 230 to regions at which no liquid was directly deposited. Also, in some cases, the liquid may flow over the interface between solid materials 230 and 220 (so that the liquid contacts the small contact area with solid material 220 only due to it flowing over solid material 230); in other cases, the liquid may be deposited directly onto this small contact area.

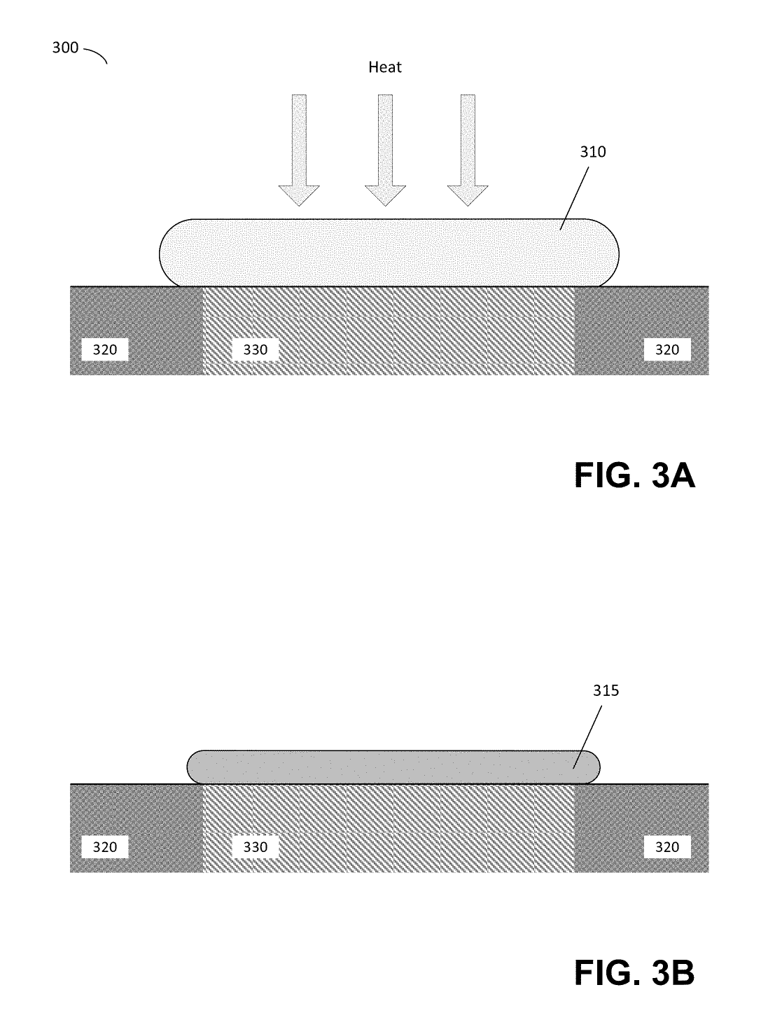

FIGS. 3A-3B are cross-sectional schematics depicting evaporation of solvent from a liquid solution deposited during additive fabrication, according to some embodiments. As discussed above, a thin layer of liquid may, in some cases, be a solvent-based liquid that can be cured by application of heat to produce a thin film. In the example of FIG. 3A, a liquid 310 has been confined by two underlying solid materials having different surface energies (the surface energy of solid material 330 being higher than that of solid material 320) as described in relation to FIG. 2 above. A heat source is applied to the liquid 310 to cure it.

In FIG. 3B, the application of the heat in FIG. 3A has substantially evaporated one or more solvent components of the liquid 310 to produce thin film 315. In some embodiments, liquid 310 may include a conductive material combined with a solvent, such that the resulting thin film 315 is conductive. For example, the liquid 310 may be a metallic ink that remains in a liquid state until the application of heat causes the evaporation of solvent and produces a metallic thin film. In some embodiments, the liquid 310 may include a semiconductive or dielectric material combined with a solvent.

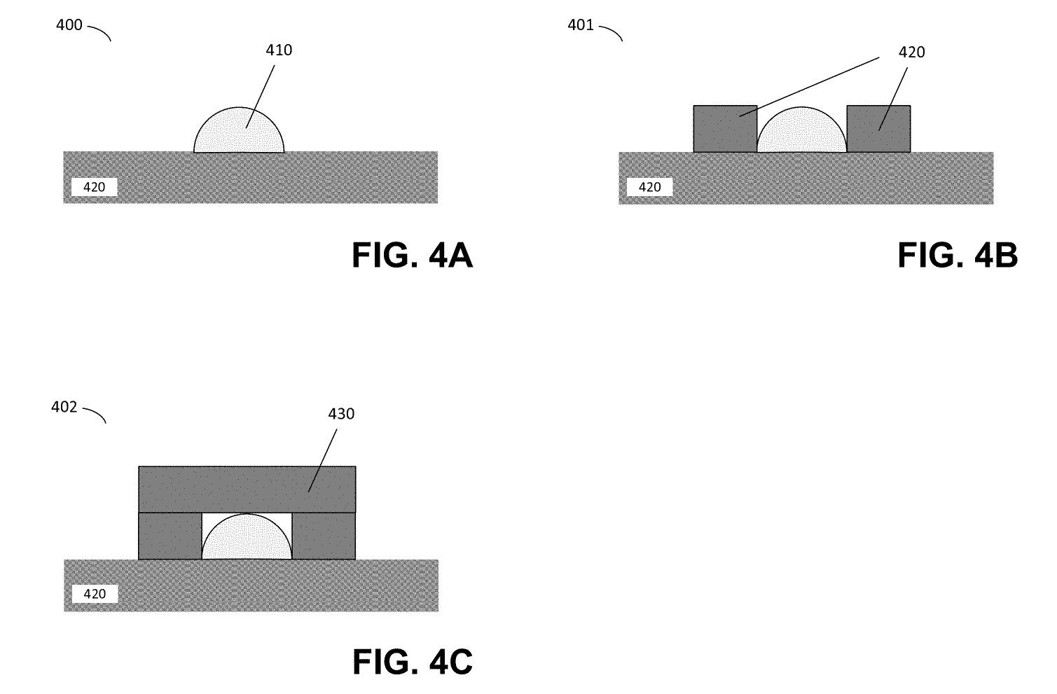

FIG. 4A-4C are cross-sectional schematics depicting encapsulation of a liquid during additive fabrication upon a low surface energy material, according to some embodiments. In the example of FIG. 4A, a liquid 410 has been deposited onto a solid material 420 that has a sufficiently low surface energy to cause the liquid 410 to partially wet the surface. As discussed above, whether the liquid exhibits partial wetting depends upon on a number of factors, including the surface energy of solid material 420 as well as properties of the liquid 410.

In FIG. 4B, solid material 430 has been fabricated alongside the liquid 410 to form sidewalls of an encapsulation volume. Interactions between the sidewalls 430 and the liquid 410 may be of little or no importance (e.g., whether the liquid wets the inner surfaces of the sidewalls or not), and accordingly the sidewalls 430 may be fabricated from any suitable material(s). For instance, sidewalls 430 may be fabricated from the same material as solid material as solid material 410, may be fabricated from one or more different materials, or may be fabricated from a combination of solid material 410 and one or more different materials. In addition, the sidewalls 430 may be fabricated in any number of additive fabrication layers.

In FIG. 4C, a ceiling 440 has been fabricated over the liquid 410 to completely encapsulate the liquid 410 within the formed encapsulation volume. As with sidewalls 430, interactions between the ceiling 440 and the liquid 410 may be of little or no importance (e.g., whether the liquid wets the inner surface of the ceiling or not), and accordingly the ceiling 440 may be fabricated from any suitable material(s). In some embodiments, the sidewalls 430 and/or ceiling 440 may be fabricated from a material with a sufficiently high surface energy to cause the liquid 410 to wet the interior surfaces of the encapsulated volume. This may be beneficial when it is desired that the liquid 410 will completely fill (or substantially fill) the encapsulated volume.

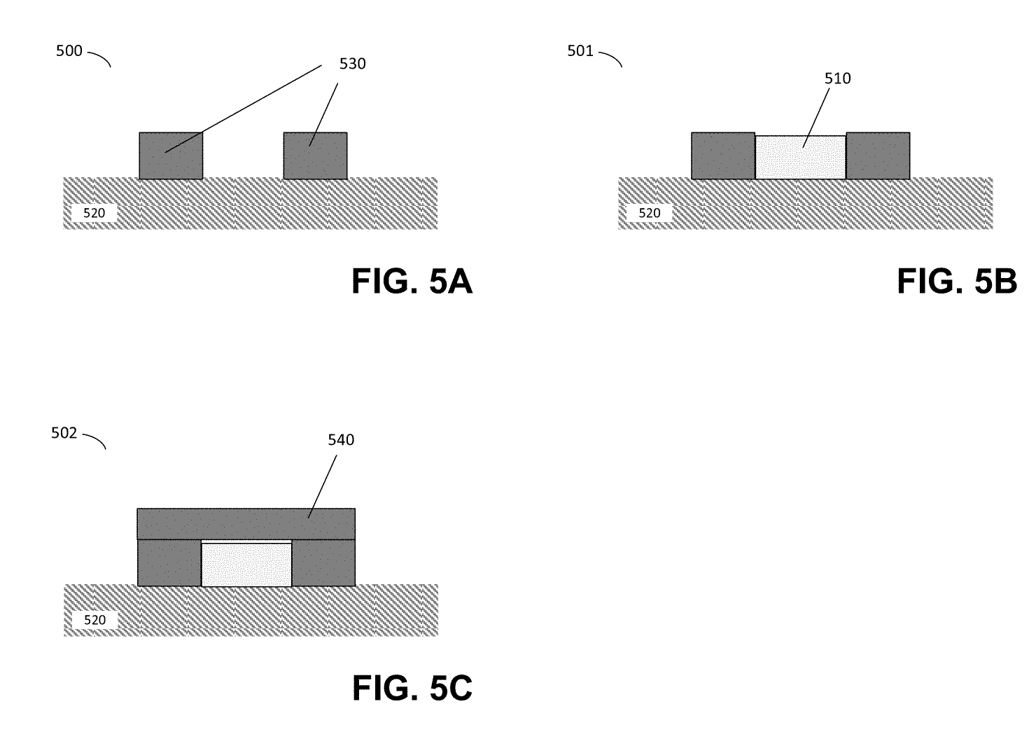

While FIGS. 4A-4C illustrate a process for encapsulating a liquid upon a surface on which the liquid exhibits partial wetting, it may in some cases be desirable to encapsulate a liquid on a surface on which the liquid exhibits full wetting. Which of these two approaches are used may be selected based on properties of the liquid to be encapsulated (e.g., how the liquid is expected to wet the solid materials available for fabrication to the additive fabrication device being used). FIG. 5A-5C are cross-sectional schematics depicting encapsulation of a liquid during additive fabrication in such a use case, according to some embodiments.

In FIG. 5A, sidewalls 530 are fabricated from solid material(s) upon a solid material 520. Solid material 520 is selected to be a solid material upon which a liquid 510 to be encapsulated will flow (e.g., it has a sufficiently high surface energy that the liquid 510 will wet its surface). Sidewalls 530 may be fabricated from any suitable material(s). For instance, sidewalls 530 may be fabricated from the same material as solid material as solid material 520, may be fabricated from one or more different materials, or may be fabricated from a combination of solid material 520 and one or more different materials.

In FIG. 5B, the liquid 510 is deposited into the well created by the sidewalls 530 in step 500 shown in FIG. 5A. Due to the above-described surface energy of the solid material 520 with respect to liquid 510, the liquid spreads out within the well. In FIG. 5C, a ceiling 540 is fabricated over the sidewalls and the liquid to encapsulate the liquid.

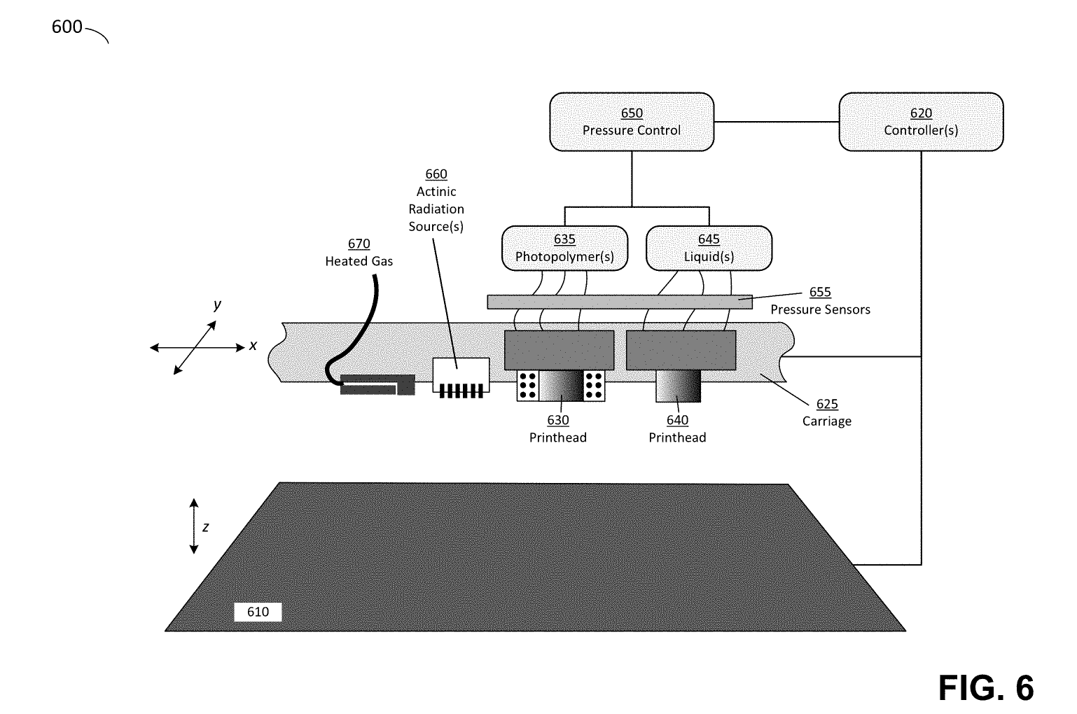

FIG. 6 illustrates an additive fabrication device suitable for practicing some aspects of the present disclosure, according to some embodiments. Illustrative additive fabrication device 600 is configured to produce solid materials via inkjet printing, in which a liquid photopolymer is deposited onto a surface and a source of actinic radiation (e.g., ultraviolet light) is directed onto the photopolymer causing it to cure into a solid. Device 600 is also configured to deposit one or more liquids by depositing droplets of the liquid(s) onto a surface.

In the example of FIG. 6, additive fabrication device 600 includes a build platform 610 upon which objects can be fabricated from a combination of one or more cured photopolymers and one or more liquids. As discussed above, the flow of deposited liquids may be controlled by selecting the surface energies of the produced solid materials. Furthermore, thin films may be formed from suitable deposited liquids by application of heat (as shown by the example of FIGS. 3A-3B) and/or encapsulated liquids may be produced (as shown by the examples of FIGS. 4A-4C and FIGS. 5A-5C). Illustrative additive fabrication device includes components configured to produce objects whilst utilizing any number of these techniques. One such illustrative object is discussed in greater detail below in the context of FIGS. 7A-7E.

While the example of FIG. 6 presents an additive fabrication device that forms solid material using liquid photopolymers, it will be appreciated that the techniques described herein are applicable to solid materials formed using other additive fabrication techniques as well. For instance, as described above, solid material may be formed from a liquid epoxy in some embodiments. In some embodiments, an additive fabrication device may be configured to form solid material from both liquid photopolymer(s) and liquid epoxy or epoxies.

In the example of FIG. 6, additive fabrication device 600 includes, or is coupled to, one or more controllers 620 which control motion of the build platform 610, and by moving the carriage 625, the motion of printheads 630 and 640, actinic radiation source 660 and heated gas source 670. In some embodiments, the controller(s) 620 may include one or more general purpose processors (including CPUs and/or microprocessors) programmed to perform any number of these control operations and/or may include one or more customized circuits (e.g., ASICs) configured to perform any number of these control operations. The controller may be configured to fabricate an object from one or more materials, as discussed below, according to computer-readable instructions provided to the controller. These instructions may include instructions to move the carriage and build platform, to produce material from the printheads 630 and/or 640, to apply heated gas from element 670, turn off and turn on the actinic radiation source 660, etc. Each of the controller(s) 620 may be located within a common housing of the additive fabrication device as the other pictured elements in FIG. 6, or may be located in another device coupled to these elements (e.g., in a computer connected via a wireless and/or wired connection).

In the example of FIG. 6, the build platform 610 is configured to move along a vertically-aligned z-axis, whereas the carriage 625 is configured to move along x- and y-axes that are both perpendicular to the z-axis. Any number of motors or other such actuators may be arranged to move these elements along the pictured axes. It will be appreciated that the particular axes of motion of the build platform and carriage shown in FIG. 6 is provided merely as one illustrative example, and other configurations are possible so long as the components of the carriage (e.g., printheads) can be positioned at desired locations within a three dimensional build volume relative to the surface of the build platform.

In the example of FIG. 6, the controller(s) 620 operate pressure control module 650, which controls production of liquid photopolymer(s) 635 and production of liquid(s) 645 via printheads 630 and 640, respectively. According to some embodiments, either or both of printheads 630 and 640 may include multiple nozzles that may be actuated independently to produce liquid(s). In some embodiments, the additive fabrication device 600 may be configured to produce different liquids from different nozzles of the same printhead simultaneously, and/or to produce liquid from the two printheads 630 and 640 simultaneously.

As discussed above, production of liquid droplets from the printhead may be controlled by any suitable actuator. In some embodiments, the pressure control module 650 controls a piezoelectric actuator that controls production of liquid droplets at the printheads 630 and 640. In such cases, a voltage waveform optimized for each type of liquid (each type of liquid photopolymer and each type of liquid amongst the liquid(s) 645) may be applied to an actuator coupled to a source of the liquid. Such waveforms may be stored in a computer readable medium accessible to the controller(s) 620 and accessed by the controller(s) and/or the pressure control module 650 in order to activate the actuator according to instructions for additive fabrication.

According to some embodiments, to apply a liquid over an area (referred to herein as a “patch”), multiple passes of one or more printhead nozzles may be performed, with each pass depositing liquid in portions of the patch. For instance, the patch may be divided into a grid and material may be deposited to fill each of a subset of the grid cells in a first pass of the printheads, then deposited to fill each of a second subset in a second pass, etc., until material has been deposited over the entire patch.

According to some embodiments, one or both of printheads 630 and 640 may include an internal heating element. The viscosity of one or more of the photopolymer(s) 635 and/or liquid(s) 645 may vary with temperature and it may be beneficial to increase the temperature of the liquids to allow greater control of the fluid flow out of the respective printhead. For example, one or both of the printheads may include a cartridge heater heated to a temperature between 50° C. and 100° C., such as around 70° C.

According to some embodiments, heated gas unit 670 may be configured to pass pressurized air over a heating element and output the heated air through one or more nozzles or other outlet(s). For example, a metal block may be heated by an internal ceramic heating element and may include internal channels that heat incoming air and disperse it through an array of holes (e.g., holes around 0.5 mm to 5 mm in diameter, such as around 1 mm). Application of air into the heating element may be controlled by the controller(s) 620 in accordance with the above-referenced fabrication instructions. As discussed above, the heated air may be used to cure solvent-based liquids previously produced from printhead 640.

According to some embodiments, photopolymer(s) 635 may include a plurality of UV-curable photopolymers that, once cured to solid material, have different surface energies and different elastic moduli. For example, the photopolymer(s) 635 may include a first liquid photopolymer that forms an elastic material once cured (e.g., having an elastic modulus between 500 kPa and 10 MPa, or between 600 kPa and 2 MPa) and a second liquid photopolymer that forms a rigid material once cured (e.g., having an elastic modulus above 200 MPa, or above 500 MPa, or above 700 MPa). In some embodiments, the photopolymer(s) 635 include one or more UV-curable acrylate polymers.

According to some embodiments, liquid(s) 645 may include one or more electrolyte solutions. For instance, a electrolyte dissolved into a suitable solvent, such as water, may be produced from the printhead 640. According to some embodiments, liquid(s) 645 may include one or more solvent-based liquids, such as liquids comprising one or more organic solvents (e.g., dimethyl sulfoxide and/or ethanol). The solvent-based liquids may include a conductive material (e.g., a metal such as copper or silver, carbon/graphite, a conductive polymer, etc.), an insulator (e.g., polyimide), a dielectric, a ferromagnetic material, etc., in combination with one or more solvents. As such, the liquid(s) 645 may include conductive inks, insulating inks, dielectric inks, ferromagnetic inks, etc. In general, any liquids suitable for encapsulation and/or use to produce thin films via the application of heat may be used in additive fabrication device 600 as the techniques described herein are not limited to any particular materials.

It will be appreciated that, while the illustrative additive fabrication device of FIG. 6 depicts a single printhead for each of the photopolymer(s) and liquid(s), in general any number of printheads including any suitable number of nozzles may be employed in an additive fabrication device. For instance, in addition to a printhead configured to produce photopolymer(s), one functional liquid may be dispensed from a heated printhead whilst a different function liquid may be dispensed from a different, non-heated printhead. The techniques for producing functional composites and/or structures are not limited to any particular arrangement of printheads and nozzles.

FIGS. 7A-7E discuss various aspects of an illustrative sensory composite device produced via the above-described techniques. The device includes a strain sensor coupled to an electrochromic pixel element via an organic electrochemical transistor (OECT)-based amplifier (also referred to herein as a common-source amplifier) that adjusts the transparency of the electrochromic pixel in response to an amount of strain detected by the strain sensor. This device was inspired by the dense packing of diverse functions that produce sensing and actuation mechanisms in nature, such as in the Golden tortoise beetle, which modulates the transparency of its exoskeleton when stressed.

FIG. 7A is a photograph of the sensory composite device produced via additive fabrication, according to some embodiments. The device includes two solid polymer materials each produced from UV curable acrylic polymer materials. The first solid material is a rigid material (elastic modulus of around 640 MPa), which appears as the dark material in FIG. 7A; and the other solid material is a flexible, elastic material (elastic modulus of around 680 kPa), which appears as the substantially transparent material in FIG. 7A. The rigid material has a surface energy of around 45 mJ/m², whereas the elastic material has a surface energy of around 28 mJ/m².

In the example of FIG. 7A, the strain sensor includes multiple layers of silver nanoparticles produced from a silver ink to which heat was applied, thereby evaporating the solvent of the ink and producing precipitated silver nanoparticles. The silver is sandwiched between portions of the elastic polymer, thereby producing a stretchable strain-sensitive resistor. An outer shell of the rigid polymer is provided at the electrical contacts (at the end points of the strain sensor), which is described in greater detail below in relation to FIG. 7D.

The common-source amplifier includes a channel and gate fabricated from poly(3,4-ethylenedioxythiophene) doped with polystyrene sulphonate (PEDOT:PSS). The PEDOT:PSS is deposited as a solvent-based liquid with a dimethyl sulfoxide solvent, which is evaporated by application of heat, as discussed above, to produce a thin film of PEDOT:PSS. The channel and gate are bridged by a water-based electrolyte containing potassium ions which is encapsulated inside a well. The amplifier is further described in relation to FIG. 7E below.

FIG. 7B shows an exploded view of the sensory composite device shown in FIG. 7A, and FIG. 7C shows an equivalent circuit diagram of the strain sensor ladder, the common source amplifier and electrochromic pixel of the illustrative device of FIG. 7A.

FIG. 7D is a cross-sectional schematic of an additively fabricated electric contact structure, according to some embodiments. The electrical contacts of the above-described sensory composite device utilize the pyramidal structure 700 within electrical contact regions to enhance the mechanical robustness of the electrical contacts.

When the resistance of the strain sensor changes, the voltage input to the amplifier changes, which causes a change in the voltage across the electrochromic pixel. The optical contrast in the optical absorption spectrum between oxidized (transparent) and reduced states of a PEDOT:PSS film is used to produce the switchable transparency element of the electrochromic pixel.

In structure 700, a solid material 720 is fabricated along with a solid material 730 to form the solid matrix of the electrical contact. A conductive film (silver nanoparticles in the case of the illustrative sensory composite device) 750 is fabricated over the pyramidal structures formed from solid material 730 and sandwiched between portions of the solid material 720. The conductive film 750 may extend outward from the pyramidal electrical contact region into the remainder of the object, as illustrated by the dashed lines in FIG. 7D. In the example of the sensory composite device shown in FIG. 7A, the conductive film and the elastic polymer in which it is sandwiched extend across the length of the strain sensor, with the pictured electrical contact structure being provided at each end of the sensor.

To provide a practical illustration of the above-described techniques of fluid control, the fabrication of structure 700 will be described. While structure 700 is depicted with pyramidal structures, it will be appreciated that other shapes may also be produced from solid material to control fluid flow. For instance, structures having a sinusoidal cross sectional shape, structures formed from portions of spheres, etc. Each of these types of structures include concave regions into which, or within which, fluid can flow such that the fluid can be directed to certain locations on the surface due to the natural flow of the fluid due to gravity. For instance, the pyramid structures shown in FIG. 7D have a lowest point in each concave region (each “V”-shaped region) such that liquid may tend to flow down to the lowest point in each “V”.

In the example of FIG. 7D, solid material 730 is selected to have a surface energy such that the liquid from which the conductive film will be formed will flow over its surface. Solid material 720 is selected to have a surface energy such that the liquid from which the conductive film will be formed will exhibit partial wetting on its surface. As structure 700 is fabricated in layers from the bottom to the top of the figure, initially a number of layers containing regions of solid material 720 and regions of solid material 730 are formed.

When the base of the pyramidal structure is reached (at the height labeled “h” in FIG. 7D) a liquid (e.g., a conductive ink, a functional liquid, a solvent-based liquid, etc.) begins to be deposited, layer by layer, along with and on top of the solid material 730. At the boundaries of the electrical contact, material 720 is deposited, which ensures that the liquid will flow over the solid material 730 but will be controlled at the boundaries of the region of solid material 730 due to the wetting behavior of the liquid on solid material 720. For instance, the behavior may be analogous to that shown in FIG. 2, where a liquid flows over one solid material but another solid material is deposited at an interface to control the fluid at the interface.

When the liquid is deposited onto the solid material 720 directly (in the region at the right hand side of structure 700 shown in FIG. 7D), since the liquid does not flow over this surface, the liquid is deposited in droplets that cover the desired surface of the solid material 720. As discussed above, one way to do this is to produce droplets of the liquid in a number of passes of the printhead, where each pass produces liquid at a plurality of locations (e.g., squares of a grid) such that the entire “patch” is eventually filled in with liquid.

FIG. 7E is a cross-sectional schematic of an additively fabricated transistor structure, according to some embodiments. The depicted transistor structure 701 is utilized in the illustrative above-described sensory composite device as shown in FIGS. 7A-7C to produce the common source amplifier described above.

In the example of FIG. 7E, a p-type transistor is formed by a conductive polymer 750 (e.g., PEDOT:PSS) that forms the channel and gate of the transistor. The channel and gate are bridged by an electrolyte 760 (e.g., a water-based electrolyte containing potassium ions) that is encapsulated inside a wall whose size defines the channel dimensions. Conductive films 740 form the source and drain of the transistor, and may be, for example, metallic films, conductive carbon films, etc. The channel of the depletion mode organic electrochemical transistor (OECT) is dedoped by the physical movement of metal ions from the electrolyte when a positive gate voltage is applied. This transistor can be connected to an active load to form an amplifier.

In the example of FIG. 7E, the solid material 730 is a rigid material having a comparatively high surface energy and the solid material 720 is an elastic material having a comparatively low surface energy. In particular, the three liquids utilized to produce the structure 701 (i.e., the electrolyte, conductive polymer ink and conductive ink used to form structures 760, 750 and 740, respectively) exhibit partial wetting on the surface of solid material 720. The solid material 720 is used as a build surface on which to fabricate the conductive thin films 740 and conductive polymer film 750, since these liquids do not flow on its surface. In addition, the liquid electrolyte, which is not cured to a thin film unlike the other liquids utilized in fabrication of structure 701, also does not flow on the surface of solid material 720 and thereby can be controlled whilst it is encapsulated (e.g., as in the process shown in FIGS. 4A-4C).

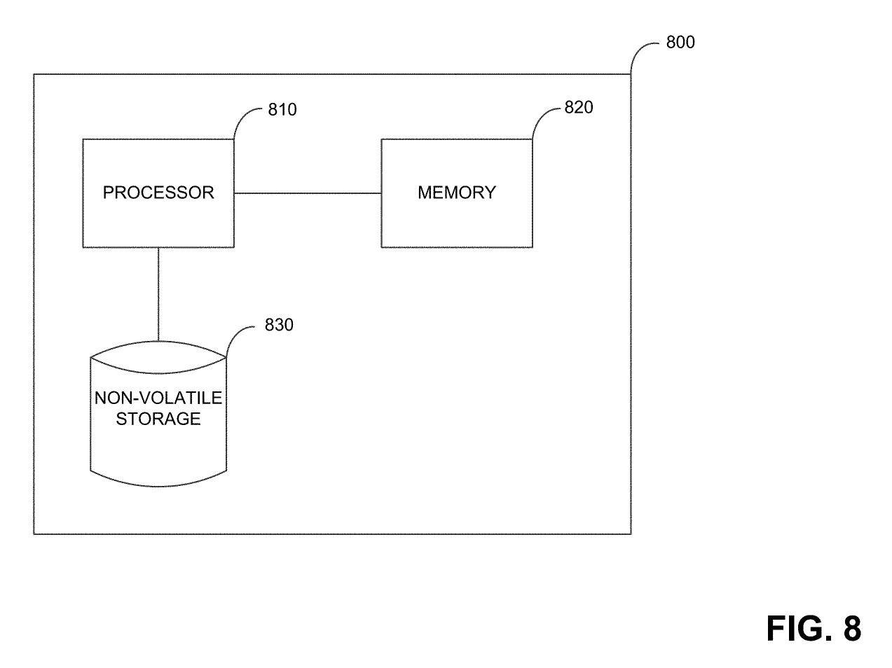

An illustrative implementation of a computer system 800 that may be used to control an additive fabrication device, such as additive fabrication device 600 shown in FIG. 6, is shown in FIG. 8. The computer system 800 may include one or more processors 810 and one or more non-transitory computer-readable storage media (e.g., memory 820 and one or more non-volatile storage media 830). The processor 810 may control writing data to and reading data from the memory 820 and the non-volatile storage device 830 in any suitable manner, as the aspects of the invention described herein are not limited in this respect. To perform functionality and/or techniques described herein, the processor 810 may execute one or more instructions stored in one or more computer-readable storage media (e.g., the memory 820, storage media, etc.), which may serve as non-transitory computer-readable storage media storing instructions for execution by the processor 810.

In connection with techniques described herein, code used to, for example, produce instructions for fabrication of a composite structures and/or devices (e.g., perform “slicing”), and/or to execute such instructions by controlling an additive fabrication device to fabricate an object, may be stored on one or more computer-readable storage media of computer system 800. Processor 810 may execute any such code to provide any techniques for additive fabrication of composite structures and/or devices as described herein. Any other software, programs or instructions described herein may also be stored and executed by computer system 800. It will be appreciated that computer code may be applied to any aspects of methods and techniques described herein. For example, computer code may be applied to interact with an operating system to control an additive fabrication device.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method of forming an object via additive fabrication, the method comprising:
forming a first layer of the object by depositing a plurality of droplets of a first liquid and curing the first liquid to form solid material, the first layer including:
a region of a first solid material; and
a region of a second solid material in contact with the region of the first solid material; and
depositing a second liquid onto the region of the first solid material and at least part of the region of the second solid material,
wherein the second liquid, once deposited, uniformly spreads over the region of the first solid material whilst exhibiting partial wetting over the at least part of the region of the second solid material.

2. The method of claim 1, wherein the first liquid is a photopolymer and curing the first liquid comprises directing actinic radiation onto the photopolymer.

3. The method of claim 1, wherein curing the first liquid comprises chemically reacting the first liquid with one or more other substances to form the solid material.

4. The method of claim 1, wherein the second solid material has a lower surface energy than the first solid material.

5. The method of claim 1, wherein the first solid material is a rigid material and the second solid material is an elastic material.

6. The method of claim 1, further comprising directing heat onto the second liquid that causes evaporation of a solvent component of the second liquid.

7. The method of claim 1, wherein the second liquid comprises an electrically conductive material and/or a semiconductive material.

8. The method of claim 1, wherein the second liquid comprises a dielectric material.

9. The method of claim 7, wherein the electrically conductive material is poly(3,4-ethylenedioxythiophene) doped with polystyrene sulphonate (PEDOT:PSS).

10. The method of claim 7, wherein the electrically conductive material is silver.

11. The method of claim 1, wherein the second liquid comprises an organic solvent.

12. The method of claim 1, further comprising forming additional solid material onto the second liquid, then subsequently removing the second liquid whilst in a liquid form.

13-40. (canceled)
